(19) United States
(12) Patent Application Publication
(10) Pub. No.: US 2013/0320588 A1
(43) Pub. Date: Dec. 5, 2013

(54) PROCESS FOR CONNECTING TWO PLASTICS ELEMENTS TO GIVE A COMPONENT

(71) Applicant: BASF SE, Ludwigshafen (DE)

(72) Inventors: Gijsbrecht Jacobus Maria Habraken, Mannheim (DE); Manoranjan Prusty, Mannheim (DE); Alireza Talebloo, Mainz (DE); Tobias Pfefferkorn, Ludwigshafen (DE); Andreas Wollny, Freinsheim (DE); Andreas Radtke, Mannheim (DE); Jörg Schnorr, Ludwigshafen (DE); Oliver Geiger, Schwegenheim (DE); Sameer Nalawade, Mannheim (DE)

(73) Assignee: BASF SE, Ludwigshafen (DE)

(21) Appl. No.: 13/905,865

(22) Filed: May 30, 2013

Related U.S. Application Data
(60) Provisional application No. 61/653,442, filed on May 31, 2012.

(51) Int. Cl. B29C 45/00

(52) U.S. Cl. CPC B29C 45/0005
USPC 264/257

(57) ABSTRACT

The invention relates to a process, comprising the following steps, for connecting two plastics elements to give a component, where a second plastics element is connected to a first plastics element by molding-on in a molding process or forming process:
(a) inserting the first plastics element into a mold, where the first plastics element comprises at least one thermoplastic as matrix material,
(b) introducing a plastics molding composition into the mold for molding the second plastics element, where the plastics molding composition comprises at least one thermoplastic having reactive groups or one mixture made of at least one thermoplastic and of a material having reactive groups which react chemically with reactive groups of the thermoplastic of the first plastics element.

The invention is based on a process for connecting two plastics elements to give a component in which, in a first step, a first plastics component is inserted into a mold and in a second step a plastics molding composition for forming the second plastics element is introduced into the mold.

Corresponding processes are used by way of example when the intention is to inject ribs onto plastics components made from a fiber-reinforced polymer, for reinforcement thereof. In another use of corresponding processes, a second polymer composition is used for in-mold coating of, for example, parent structures made of a reinforced polymer material, with the aim of influencing surface properties.

In order to obtain good connection between the first plastics element and the plastics molding composition of the second plastics element, the first plastics element is usually preheated. The preheating here can take place prior to insertion into the mold or alternatively through an additional heating system, for example an infrared source, in the mold. The preheating preferably softens the first plastics element and optionally causes incipient melting at the surface. In order to avoid deformation of the softened first plastics element, the first plastics element is usually heated in the mold. By virtue of the preheating and optional incipient melting of the first plastics element, the polymers of the first plastics element and of the second plastics element become welded, and a secure connection is produced.

In order that sufficient strength is obtained, in particular when the second plastics element comprises ribs which are intended to reinforce the component made of the first plastics element, it is necessary that melting of the first plastics molding proceeds to a sufficient depth, so that a stable welded connection is produced. By virtue of the heating of the first plastics element in the mold, the cycle time required before the component can be removed from the mold is high, since removal is not possible until the polymers of the plastics element and of the second plastics element have solidified to the extent that the component is dimensionally stable. The mold is usually cooled in order to achieve this.

The fusion of, and injection of material around, sheet-like plastics parts reinforced by continuous-filament fibers, known as organopanels, is described by way of example in Marco Wacker et al., “Schweiβgen and Umspritzen von Organoblechen” [Welding and in-mold coating of organopanels], KU Kunststoffe, Carl Hanser Verlag, Munich, Jahrgang 92 (2002), 6. In-mold coating can be used to attach functional elements to the organopanel. For this, the organopanel is preheated prior to insertion into the mold, and then is in-mold coated with a second polymer. However, this leads to the disadvantages described above, by virtue of the cycle times and the high molds required.

It is therefore an object of the present invention to provide a process which can connect two plastics elements and which provides a stable connection of the plastics elements and can give lower production-cycle times.

The object is achieved through a process, comprising the following steps, for connecting two plastics elements to give a component, where a second plastics element is connected to a first plastics element by molding-on in a molding process or forming process:
(a) inserting the first plastics element into a mold, where the first plastics element comprises at least one thermoplastic as matrix material,
(b) introducing a plastics molding composition into the mold for molding the second plastics element, where the plastics molding composition comprises at least one thermoplastic having reactive groups or one mixture made of at least one thermoplastic and of a material having reactive groups which react chemically with reactive groups of the thermoplastic of the first plastics element.

For the purposes of the present invention, “molding-on” means not only the partial molding-on of plastics elements on parts of the first plastics element but also the complete or partial closure of the first plastics element.

Examples of molding processes are injection molding and flow molding, and examples of forming processes are thermoforming and pressure forming.

A stable connection between the first plastics element and the second plastics element is achieved through the chemical reaction of the reactive groups comprised in the plastics molding composition for the second plastics element with reactive groups of the thermoplastic of the matrix material of the first plastics element, for example with amino groups of a polyamide used as matrix material. Another advantage is that the extent of incipient melting required for the first plastics element is less than during the welding of two plastics elements. The process can therefore be carried out with the first plastics element at a lower processing temperature. It is therefore possible by way of example to select a lower temperature for the mold. Another possibility is, as an alternative, that the first plastics element is heated to a lesser extent before it is inserted into the mold. This also permits reduction of cycle times.

In one preferred embodiment, the first plastics element is a fiber-reinforced sheet-like plastics part. The fibers for reinforcement of the fiber-reinforced sheet-like plastics part can be short fibers, long fibers, or continuous-filament fibers. It is preferable that the fibers for reinforcement of the first plastics element are continuous-filament fibers.

If continuous-filament fibers are used for reinforcement of the first plastics element, these can have orientation parallel to one another in the form of a drawn-loop knit, of a woven, or in unidirectional or bidirectional plys. Another possibility is an arrangement of the fibers in the form of a nonwoven or felt. However, it is preferable to use the fibers in the form of textile sheet-like structure for reinforcement. It is possible here to interweave the respective fibers individually or to interweave individual fiber bundles with one another. Examples of suitable fibers which can be used for reinforcement are organic fibers, inorganic fibers from the mineral fibers, and also any desired combinations thereof. Examples of suitable fibers are synthetic fibers, carbon fibers, glass fibers, aramid fibers, boron fibers, potassium titanate fibers, mineral fibers, such as basalt fibers, and metallic fibers, such as steel fibers or copper fibers, and also any desired combinations thereof.

To produce the fiber-reinforced first plastics part, the fibers, to the extent that these take the form of woven or knit, are impregnated with a thermoplastic as matrix material. The production process uses the thermoplastic by way of example in the form of a melt for impregnation or embedding, with the fibers. Another possibility, as an alternative, is to impregnate the fibers with monomers for producing the thermoplastic and then, for example, to use heating to bring about a reaction which leads to the polymerization of the monomers. Another possibility for producing the sheet-like first plastics element is powder impregnation or the lamination of the fibers with polymer foils, and then melting and pressing of the polymer foils, to produce the first plastics part.

This type of flat, sheet-like plastics part is also generally termed organopanel.

Examples of thermoplastics suitable as matrix material for the first plastics element and as plastics molding composition for the second plastics element are polyolefins, such as polyethylene or polypropylene, polyvinyl polymers, such as polyvinyl chloride (PVC), polyvinyl acetals, polyvinyl ethers, polyvinyl lactams or polyvinylamines, styrene polymers, such as polystyrene, styrene-acrylonitrile copolymers, acrylonitrile-butadiene-styrene, polymers of (meth)acrylic acid, for example polyacrylic acid, poly(meth)acrylic esters, polyacrylates, polymethyl methacrylate, polyacrylamide, polycarbonates, polyoxymethylene, polyphenylene ethers, polytetrafluoroethylene, polyphenylene sulfide, polyether sulfones, polyether ketones, polyimides, polyquinoxalines, polyquinolines, polybenzimidazoles, polyamides, polyesters, or polyurethanes, such as polyisocyanates, polyols, polyether polyols, polyester polyols.

Polyamides are particularly preferred as matrix material for the first plastics element. Suitable polyamides are for example composed of lactam X, diamine Y, dicarboxylic acid or mixtures thereof as monomer units.

Lactams X which can be used as monomer units for producing the polyamide preferably comprise 6 to 12 ring members. Suitable are for example valerolactam, caprolactam, oenanthe lactam, capryl lactam or lauryl lactam. Besides the lactams also amino acids which result from the opened lactams are suitable. Caprolactam is particularly preferred as lactam.

Diamines Y which can be used as monomer units are such of the general formula H₂N—R¹—NH₂ with R¹ being 1,3- or a 1,4-phenylene or an unbranched or branched alkylene with 4 to 38 carbon atoms, particularly 4 to 8 carbon atoms, which may comprise a cycloalkylene. Suitable diamines are for example 1,4-diamino butane, 1,5 pentane diamine, methyl pentane diamine, hexamethylene diamine, octamethylene diamine, nonane diamine, decamethylene diamine, undecane diamine, dodecane diamine, 1,3-phenylene diamine, 1.4-phenylene diamine, 4,4′-diamino dicylclohexyl methane, 3,3′-dimethyl-4,4′diamino dicyclohexl methane, 2,2,4-trimethyl hexamethylene diamine and xylylene diamine.

Suitable dicarboxylic acids Z a such of the general formula HOOC—R²—COOH, wherein R² is 1,3- or a 1,4-phenylene or an unbranched or branched alkylene with 4 to 38 carbon atoms, particularly 4 to 8 carbon atoms, which may comprise a cycloalkylene. Suitable dicarboxylic acids are for example adipic acid, azelaic acid, sebacic acid, suberic acid, dodecanedioic acid, terephthalic acid, isophthalic acid or napthalenic acid. Particularly preferred are adipic acid, dodecanedioic acid, terephthalic acid and isophthalic acid.

Polyamides, for example, may be composed of monomers in following combinations: X, Y.Z, X/Y.Z, Y.Z/X, X/Y.Z/Y.Z, Y.Z/Y.Z and Y.Z/Y.Z/Y.Z. Suitable polyamides are for example PA6, PA12, PA4.6, PA66, PA6.10, PA6.12, PA10.10, PA12.12, PA13.13, PA6.T, PA9.T, PA MXD.6, PA6/6.6, PA6/6.T, PA6.l/6.T, PA6/6.6/6.10. Particular preference is given to nylon-6, nylon-6,6, nylon-4,6, nylon-6,10, nylon-6,T copolyamides, and nylon-6/6,6.

In order to adjust the properties of the first plastics element, the thermoplastic used as matrix material can also comprise additives. Examples of these are UV stabilizers, lubricants, nucleating agents, dyes, plasticizers, or any other additives which are known to the person skilled in the art and which are used to adjust the properties of a thermoplastic.

In one preferred embodiment, the thermoplastic used as matrix material comprises from 0 to 2% by weight of UV stabilizers, from 0 to 1% by weight of lubricants, and from 0 to 1% by weight of nucleating agents, each being based on the total weight of the compound.

It is particularly preferable that the thermoplastic used for the first plastics part comprises a polyamide which has more than 20 mmol/kg of terminal amino groups. It is more preferable that the number of terminal primary amino groups is greater than 25 mmol/kg. The number of terminal primary amino groups can be adjusted during the production process by using an appropriate ratio of terminal amino to terminal carboxylic acid groups in the monomers. This specific number of terminal primary amino groups increases the heat resistance and/or hydrolysis resistance of the first plastics part.

The terminal amino groups can be determined by means of titration of a solution of the polyamide in the presence of an indicator. For this, the polyamide is dissolved, with heating, in a mixture of phenol and methanol (for example 75% by weight of phenol and 25% by weight of methanol). The mixture can by way of example be kept at reflux at the boiling point until the polymer has dissolved. A suitable indicator or an indicator mixture, for example methanolic solution of benzyl orange and methylene blue, is admixed with the cooled solution, and titrated with a methanol-containing perchloric acid solution in glycol until color change occurs. The concentration of terminal amino groups is calculated from the amount of perchloric acid used.

Other suitable processes for determining terminal primary amino groups are described by way of example in WO 2008/022910.

The component is produced by inserting the first plastics element into a mold. By way of example, it is possible here to premold the first plastics element, in particular if this involves a sheet-like plastics element, in a first mold, and to insert the resultant preform into the mold. Another possibility, as an alternative, is to insert the sheet-like plastic element into the mold and to subject it to a forming process directly in the mold. However, it is preferable to premold the first plastics element and to insert the preform into the mold. Another possibility is to heat the first plastics element prior to insertion into the mold, or, as an alternative, to heat the first plastics element in the mold. The temperature selected here can be lower than the temperature that would be necessary if the first plastics element is welded to the plastics molding composition of the second plastics element through mutual melting. In particular, it is preferable to preheat the first plastics element and to insert the preheated first plastics element into the mold.

The temperature of the mold is preferably in the range from 40 to 210° C., in particular in the range from 80 to 120° C. Before insertion into the mold, the first plastics element is preferably heated to a temperature in the range from 30 to 190° C., in particular in the range from 120 to 170° C.

After insertion of the first plastics element, the plastics molding composition is introduced into the mold for the molding of the second plastics element. It is possible here either to mold the plastics molding composition locally onto the first plastics element at prescribed positions or, as an alternative, to enclose the first plastics element entirely or to some extent with plastics composition. If the first plastics element is enclosed entirely or to some extent, another possibility is that functional elements are also formed from the second molding composition. Examples of suitable functional elements are reinforcing elements, such as ribs.

The formation of the functional elements, such as ribs, can additionally reinforce the first plastics element. The resultant component thus has, by way of example, higher strength and stiffness.

The process of the invention can not only improve properties, for example increase strength through additional ribs, but can also change surface properties, for example in that a thin layer made of the plastics molding composition for the second plastics element flows over the first plastics element. It is thus possible by way of example to produce a surface with better optical properties.

In the invention, the plastics molding composition for the second plastics element comprises a thermoplastic having reactive groups or one mixture made of at least one thermoplastic and of a material having reactive groups which react chemically with reactive groups of the thermoplastic of the first plastics element.

It is particularly preferable to use a polyamide as thermoplastic for the plastics molding composition for the second plastics element.

The thermoplastic comprised in the mixture for the plastics molding composition for the second element can be the same as the thermoplastic that forms the matrix material of the first plastics element. However, it is also possible, as an alternative, to use different thermoplastics. It is also possible for the plastics molding composition to use mixtures made of different thermoplastics.

If a polyamide is used as thermoplastic for the matrix material for the first plastics element, it is advantageous that a polyamide is likewise used as thermoplast for the plastics molding composition for the second plastics element. The polyamide for the matrix material here is preferably the same as the polyamide for the plastics molding composition for the second plastics element. However, it is also possible, as an alternative, to use different polyamides or polyamide mixtures. By way of example, it is particularly preferable, for producing surfaces with better optical properties, that the plastics molding composition comprises at least some content of a polyamide which has low crystallinity. A smoother surface is thus achieved. An example of a suitable polyamide with relatively low crystallinity is PA 6/6.6. This can be comprised alone or in any desired mixture with another polyamide in the plastics molding composition for the second plastics element.

The plastics molding composition for the second plastics element can comprise other additives in order to adjust its properties. Examples of appropriate additives are impact modifiers, lubricants, heat stabilizers, UV stabilizers, fillers, and fibers for reinforcement.

Examples of impact modifiers used are ester-functionalized olefins. The proportion of impact modifiers is preferably in the range from 0 to 10% by weight, based on the total weight of the compound.

Lubricants, heat stabilizers, and UV stabilizers used can comprise any desired substances known to the person skilled in the art. It is preferable that the plastics molding composition for producing the second plastics element comprises from 0 to 1% by weight of a lubricant, from 0 to 4% by weight of heat stabilizers, and from 0 to 2% by weight of UV stabilizers, each being based on the total weight of the compound.

The plastics molding composition for the second plastics element can additionally also comprise reinforcing agents. Examples of suitable reinforcing agents are fibers, preferably short fibers or long fibers. The proportion of fibers in the plastics molding composition for the second plastics element is preferably in the range from 10 to 50% by weight, based on the entirety of the plastics molding composition.

Fibers that can be used comprise organic, inorganic, or mineral fibers, and also any desired combinations thereof. Examples of suitable fibers are glass fibers, carbon fibers, synthetic fibers, aramid fibers, potassium titanate fibers, mineral fibers, such as basalt fibers, metallic fibers, such as steel fibers or copper fibers, and boron fibers. It is particularly preferable to use carbon fibers and glass fibers. It is very particularly preferable to use short glass fibers.

If a polyamide is used as matrix material for the first plastics element, the material comprised in the plastics molding composition for the second plastics element and having reactive groups is preferably one selected from maleic anhydrides, epoxides, esters, isocyanates, oxazolines, oxazinones, a mixture of at least two of said components, or a polymer or oligomer which is composed of one or more of said components. During introduction into the mold, the reactive groups of said materials react with the terminal primary amino groups of the polyamide of the first plastics element.

A reaction with other amino groups or carboxylic acid groups of the polyamide can also take place. However, it is preferable to use a polyamide having terminal primary amino groups which react with the reactive groups of the material having the reactive groups.

The proportion of material having reactive groups in the plastics molding composition for producing the second plastics element is preferably in the range from 0 to 5% by weight, based on the total weight of the compound.

If a maleic anhydride is used as a material having reactive groups, preference is in particular given to monomeric maleic anhydride or styrene-maleic anhydride copolymers. The molar mass of suitable styrene-maleic anhydride copolymers is in the range from 1000 to 200 000 g/mol. The copolymer preferably comprises from 5 to 50 mol % of maleic anhydride, based on the monomer units of the styrene-maleic anhydride copolymer. During production of the plastics molding composition with styrene-maleic anhydride copolymer as material having reactive groups, from 5 to 50% of the maleic anhydride groups generally react with the available terminal amino groups of the polyamide of the plastics molding composition to form the second plastics molding.

If an epoxide is used, preference is given in particular to styrene-glycidyl (meth)acrylate copolymers. The molar mass of these is preferably in the range from 1000 to 200 000 g/mol. The styrene-glycidyl (meth)acrylate copolymer preferably comprises from 2 to 50 mol % of glycidyl (meth)acrylate, based on the monomer units of the styrene-glycidyl (meth)acrylate copolymer. In the case of the styrene-glycidyl (meth)acrylate copolymer, as is also the case with the styrene-maleic anhydride copolymer, the reactive groups react during the production of the plastics molding composition for the second plastics element. From 5 to 50% of the epoxy groups therefore generally react with the available terminal amino groups of the polyamide of the plastics molding composition for producing the second plastics element. Other suitable epoxides, alongside styrene-glycidyl (meth)acrylate copolymers, are epoxides on dendrimeric or star-shaped polymer structures.

If isocyanates are used as material having reactive groups, particular preference is given to isocyanates or diisocyanates with low molecular weight, oligomeric isocyanates or diisocyanates, or polymers or dendrimers having isocyanates as pendant groups. The isocyanate groups can have been capped by oximes. During production of the plastics molding composition for the second plastics element, from 5 to 50% of the isocyanate groups can react with the available amino groups or carboxy groups of the polyamides of the plastics molding composition for producing the second plastics element.

When oxazolines or oxazinones are used as material having reactive groups, preference is in particular given to molecules which comprise oxazoline or oxazinone groups which react with the amino groups and/or carboxy groups. Another possible alternative is that the reactive groups are pendant groups of polymer structures. During the production of the plastics molding composition for the second plastics element, from 5 to 50% of the oxazoline groups/oxazinone groups react with the available terminal amino groups or terminal carboxy groups of the polyamides for producing the plastics molding composition for the second plastics element.

The plastics molding composition for the second plastics element is preferably produced in a twin-screw extruder. For this, thermoplastic, for example polyamide, and additives are introduced into a feed zone of the twin-screw extruder. It is preferable that the feed zone is cooled here. A first transition zone generally follows the feed zone. In a central zone, it is then optionally possible to add fibers to reinforce the plastic. The material having the reactive groups is added in a final zone of the extruder, before the plastics molding composition is forced through a die and, for example, pelletized.

For production of the component, the resultant thermoplastic for the second plastics element is then introduced into an injection-molding machine and melted therein, and injected into the mold in which the first plastics element has been positioned.

It is also optionally possible that the thermoplastic is melted in a single- or twin-screw extruder, discharged continuously in the form of extrudate, divided into portions, pressed in the flow-molding process in a mold in which the first plastics element has been positioned, to give the component.

The thermoplastic used for producing the plastics molding composition for the second plastics element is preferably the same as that for producing the first plastics element. It is preferable that the thermoplastic for producing the plastics molding composition for the second plastics element is a polyamide and in particular one selected from PA 6, PA 6.6, PA 4.6, PA 6.10, PA 6T copolyamides, and PA 6/6.6, and mixtures thereof. As previously mentioned above, it is particularly preferable to use the same polyamide for the first plastics element and the second plastics element. To produce optically smooth surfaces, it is moreover particularly preferable that PA 6/6.6 is also added to the plastics molding composition for the second plastics element.

The second plastics element which is connected to the first plastics element comprises by way of example ribs for reinforcement of the first plastics element. The second plastics element can moreover also be sheathing for adjusting the surface of the first plastics element. The second plastics element can also comprise, alongside ribs, any desired other functional elements which are intended to be connected to the first plastics element to form a single piece.

In order to achieve good connection of the first plastics element to the second plastics element, it is moreover advantageous that the temperature at the surface of the first plastics element is above the melting point of the thermoplastic used as matrix material. To this end it is possible by way of example, as previously described above, to heat the first plastics element before this is inserted into the mold. It is also possible, as an alternative, to heat the first plastics element in the mold.

The pressure with which the plastics molding composition for the second plastics element is introduced into the mold depends on the direction of flow of the melt. Pressures usual here are those known to a person skilled in the art and conventional for the processes of injection molding and of flow molding.

### EXAMPLES

### Comparative Example 1

An injection-molding process is used to attach a rib made of PA 6 as second plastics element to an organopanel as first plastics element using a nylon-6 having 37 mmol/kg of terminal primary amino groups, as matrix material. The mold temperature for application of the rib was 200° C. Prior to insertion into the mold, the organopanel was heated to a temperature of 160° C.

After molding-on of the rib and solidification of the polyamide, the resultant component was removed from the mold and subjected to a strength test. For this, a tensile force was exerted on the rib, and the force required to separate the rib from the organopanel was measured.

The force at which the rib separated from the organopanel was 2250 N in the case of the rib made of PA 6 produced in comparative example 1.

### Comparative Example 2

The first plastics element used comprised an organopanel using nylon-6 having 83 mmol/kg of terminal primary amino groups, as matrix material. A rib made of PA 6 was molded onto the organopanel. The production conditions corresponded to those of comparative example 1. The tensile force at which the rib separated from the organopanel was 2500 N.

### Inventive Example 1

The first plastics component used comprised the same organopanel as in comparative example 1. The plastics molding composition of which the rib was molded onto the organopanel comprised PA 6 and 1% by weight of styrene-maleic anhydride copolymer, based on the total weight of the compound. The conditions for molding-on of the rib corresponded to those of comparative example 1. The tensile force at which the rib separated from the organopanel was 3000 N.

### Inventive Example 2

The first plastics component used comprised an organopanel as in comparative example 2. PA 6 with 1% by weight of styrene-maleic anhydride copolymer, based on the total weight of the compound, was used as plastics molding composition for the second plastics element, namely the rib. The conditions for molding-on of the rib corresponded to those of comparative example 1. The tensile force at which the rib separated from the organopanel was 3500 N.

### Inventive Example 3

A rib made of PA 6 using 1% by weight of styrene-glycidyl (meth)acrylate copolymer, based on the total weight of the compound, was molded, as second plastics element, onto an organopanel of the same specification as in comparative example 2, under conditions the same as those in comparative example 1. The tensile force at which the rib separated from the organopanel was 3200 N.

1-14. (canceled)

15. A process for connecting two plastics elements to give a component, where a second plastics element is connected to a first plastics element by molding-on in a molding process or forming process which comprises the following steps
(a) inserting the first plastics element into a mold, where the first plastics element comprises at least one thermoplastic as matrix material,
(b) introducing a plastics molding composition into the mold for molding the second plastics element, where the plastics molding composition comprises at least one thermoplastic having reactive groups or one mixture made of at least one thermoplastic and of a material having reactive groups which react chemically with reactive groups of the thermoplastic of the first plastics element.

16. The process according to claim 15, wherein the first plastics element is a fiber-reinforced sheet-like or linear plastics part.

17. The process according to claim 16, wherein the fibers for reinforcing the first plastics element are continuous-filament fibers.

18. The process according to claim 16, wherein the first plastics element comprises the fibers in the form of a woven or of a laid scrim or in the form of unidirectional fiber structures.

19. The process according to claim 16, wherein the fibers have been selected from synthetic fibers, carbon fibers, glass fibers, aramid fibers, boron fibers, potassium titanate fibers, mineral fibers, and metallic fibers, and any desired combinations thereof.

20. The process according to claim 15, wherein the thermoplastic of the first plastics element is a polyamide.

21. The process according to claim 20, wherein the polyamide is PA 6, PA 6.6, PA 4.6, PA 6.10, PA 6T copolymers, or PA 6/6.6.

22. The process according to claim 15, wherein the material having the reactive groups of the plastics molding composition for the second plastics element is maleic anhydrides, epoxides, esters, isocyanates, oxazolines, oxazinones, a mixture of at least two of these components, or a polymer or oligomer composed of one or more of these components.

23. The process according to claim 15, wherein the material having the reactive groups is monomeric maleic anhydride, styrene-maleic anhydride copolymers, styrene-glycidyl (meth)acrylate copolymers, isocyanates or diisocyanates with low molecular weight, oligomeric isocyanates or diisocyanates, polymers or dendrimers having isocyanates as pendant group, or molecules which comprise oxazoline groups or which comprise oxazinone groups.

24. The process according to claim 15, wherein the thermoplastic of the plastics molding composition for the second plastics element is a polyamide.

25. The process according to claim 24, wherein the polyamide of the plastics molding composition for the second plastics element is PA 6, PA 6.6, PA 4.6, PA 6.10, PA 6T copolymers, or PA 6/6.6.

26. The process according to claim 15, wherein the plastics molding composition for the second plastics element comprises fibers, fillers, and/or other additives.

27. The process according to claim 15, wherein the second plastics element comprises ribs for reinforcement of the first plastics element.

28. The process according to claim 15, wherein the plastics molding composition for the second plastics element completely encloses the first plastics element.
